(19) United States
(12) Patent Application Publication
(10) Pub. No.: US 2017/0126789 A1
(43) Pub. Date: May 4, 2017

(54) Automatic Software Controller Configuration based on Application and Network Data

(71) Applicant: AppDynamics, Inc., San Francisco, CA (US)

(72) Inventors: Naveen Kondapalli, San Ramon, CA (US); Harish Nataraj, Berkeley, CA (US); Ajay Chandel, Fremont, CA (US)

(21) Appl. No.: 14/928,944

(22) Filed: Oct. 30, 2015

(51) Int. Cl. H04L 29/08; H04L 12/803; H04L 12/801

(52) U.S. Cl. CPC H04L 67/101; H04L 47/11; H04L 47/125

(57) ABSTRACT

The present technology may identify issues in network architectures, such as load balancers operating between machines that process a distributed business transaction, and automatically generate and apply policy updates to such machines. The present system monitors a distributed application through the applications processing the transaction as well as the network flows over which the machines communicate while processing the transaction. By monitoring the network flow and application, the system can tell when an anomaly is caused not by an application but by the network infrastructure itself. Portions of the network infrastructure, such as load balancers, may be singled out as a point of failure and automatically corrected. The failure may be a general degradation of performance or associated with the processing of a particular business transaction.

### BACKGROUND

The World Wide Web has expanded to provide numerous web services to consumers. The web services may be provided by a web application which uses multiple services and applications to handle a transaction. The applications may be distributed over several machines, making the topology of the machines that provide the service more difficult to track and monitor.

Monitoring a web application helps to provide insight regarding bottle necks in communication, communication failures and other information regarding performance of the services that provide the web application. Most application monitoring tools provide a standard report regarding application performance. Though the typical report may be helpful for most users, it may not provide the particular information that an administrator wants to know.

For example, when monitoring a web application, is important to provide as much detail as possible to a system administrator in order to correctly diagnose a problem. In many cases, a performance issue with an application is not due to the application itself, but rather due to a network that processes communications between multiple machines. It is difficult to determine how an application performance is affected by the network when only monitoring the application itself. What is needed is an improved system for monitoring applications that communicate over network.

### SUMMARY

The present technology, roughly described, may identify issues in network architectures, such as load balancers operating between machines that process a distributed business transaction, and automatically generate and apply policy updates to such machines. The present system monitors a distributed application through the applications processing the transaction as well as the network flows over which the machines communicate while processing the transaction. By monitoring the network flow and application, the system can tell when an anomaly is caused not by an application but by the network infrastructure itself. Portions of the network infrastructure, such as load balancers, may be singled out as a point of failure and automatically corrected. The failure may be a general degradation of performance or associated with the processing of a particular business transaction. In any case, the load balancer or other machine may be addressed by an automatic generation of an updated policy to correct the degradation in performance and applying the updated policy to the machine.

An embodiment may include a method for monitoring a business transaction performed. The method begins with monitoring a distributed business transaction over a plurality of machines and at least one network. An anomaly in a network machine within the network architecture may be identified that processes the distributed business transaction by a remote server in communication with the plurality of machines. A policy update may automatically be applied to the network machine in the network architecture by the remote server.

An embodiment may include a system for monitoring a business transaction. The system may include a processor, memory, and one or more modules stored in memory and executable by the processor. When executed, the modules may monitor a distributed business transaction over a plurality of machines and at least one network, identify an anomaly in a network machine within the network architecture that processes the distributed business transaction by a remote server in communication with the plurality of machines, and automatically apply a policy update to the network machine in the network architecture by the remote server.

### BRIEF DESCRIPTION OF THE DRAWINGS

FIG. 1 is a block diagram of a system for monitoring a distributed business transaction performed by applications and at least one network flow.

FIG. 2 is a block diagram of a network infrastructure.

FIG. 3 is a method for automatically monitoring and updating a network infrastructure.

FIG. 4 is a method for monitoring distributed business transactions by an application agent.

FIG. 5 is a method for monitoring distributed business transactions by a network agent.

FIG. 6 is a method automatically identifying an anomaly in a load balancer.

FIG. 7 is a method for automatically applying a policy update to a load balancer by a controller.

FIG. 8 is a block diagram of a computing environment for implementing the present technology.

### DETAILED DESCRIPTION

The present technology may identify issues in network architectures, such as load balancers operating between machines that process a distributed business transaction, and automatically generate and apply policy updates to such machines. The present system monitors a distributed application through the applications processing the transaction as well as the network flows over which the machines communicate while processing the transaction. By monitoring the network flow and application, the system can tell when an anomaly is caused not by an application but by the network infrastructure itself. Portions of the network infrastructure, such as load balancers, may be singled out as a point of failure and automatically corrected. The failure may be a general degradation of performance or associated with the processing of a particular business transaction. In any case, the load balancer or other machine may be addressed by an automatic generation of an updated policy to correct the degradation in performance and applying the updated policy to the machine.

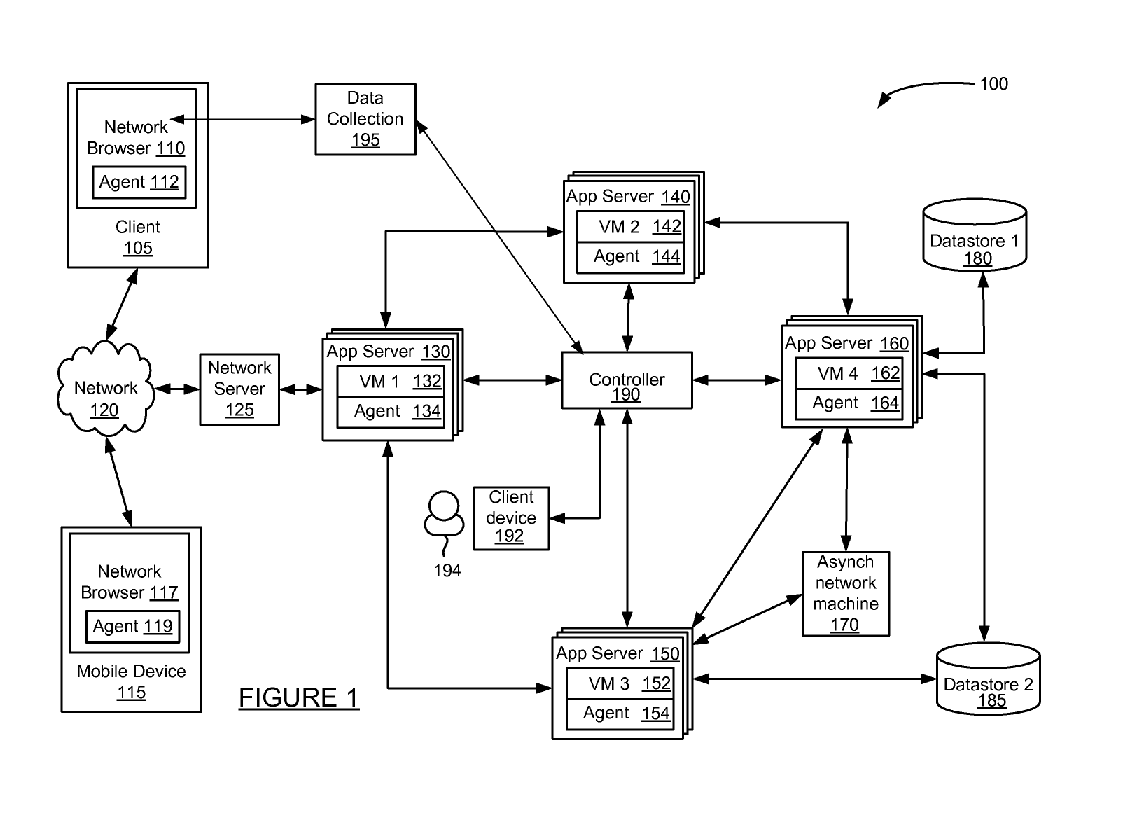

FIG. 1 is a block diagram of a system for monitoring a distributed business transaction. System 100 of FIG. 1 includes client device 105 and 192, mobile device 115, network 120, network server 125, application servers 130, 140, 150 and 160, asynchronous network machine 170, data stores 180 and 185, controller 190, and data collection server 195.

Client device 105 may include network browser 110 and be implemented as a computing device, such as for example a laptop, desktop, workstation, or some other computing device. Network browser 110 may be a client application for viewing content provided by an application server, such as application server 130 via network server 125 over network 120.

Network browser 110 may include agent 112. Agent 112 may be installed on network browser 110 and/or client 105 as a network browser add-on, downloading the application to the server, or in some other manner. Agent 112 may be executed to monitor network browser 110, the operation system of client 105, and any other application, API, or other component of client 105. Agent 112 may determine network browser navigation timing metrics, access browser cookies, monitor code, and transmit data to data collection 160, controller 190, or another device. Agent 112 may perform other operations related to monitoring a request or a network at client 105 as discussed herein.

Mobile device 115 is connected to network 120 and may be implemented as a portable device suitable for sending and receiving content over a network, such as for example a mobile phone, smart phone, tablet computer, or other portable device. Both client device 105 and mobile device 115 may include hardware and/or software configured to access a web service provided by network server 125.

Mobile device 115 may include network browser 117 and an agent 119. Mobile device may also include client applications and other code that may be monitored by agent 119. Agent 119 may reside in and/or communicate with network browser 117, as well as communicate with other applications, an operating system, APIs and other hardware and software on mobile device 115. Agent 119 may have similar functionality as that described herein for agent 112 on client 105, and may repot data to data collection server 160 and/or controller 190.

Network 120 may facilitate communication of data between different servers, devices and machines of system 100 (some connections shown with lines to network 120, some not shown). The network may be implemented as a private network, public network, intranet, the Internet, a cellular network, Wi-Fi network, VoIP network, or a combination of one or more of these networks. The network 120 may include one or more machines such as load balance machines and other machines.

Network server 125 is connected to network 120 and may receive and process requests received over network 120. Network server 125 may be implemented as one or more servers implementing a network service, and may be implemented on the same machine as application server 130 or one or more separate machines. When network 120 is the Internet, network server 125 may be implemented as a web server.

Application server 130 communicates with network server 125, application servers 140 and 150, and controller 190. Application server 130 may also communicate with other machines and devices (not illustrated in FIG. 1). Application server 130 may host an application or portions of a distributed application. The host application 132 may be in one of many platforms, such as including a Java, PHP, .Net, and Node.JS, be implemented as a Java virtual machine, or include some other host type. Application server 130 may also include one or more agents 134 (i.e. “modules”), including an application agent, machine agent, and network agent, and other software modules. Application server 130 may be implemented as one server or multiple servers as illustrated in FIG. 1.

Application 132 and other software on application server 130 may be instrumented using byte code insertion, or byte code instrumentation (BCI), to modify the object code of the application or other software. The instrumented object code may include code used to detect calls received by application 132, calls sent by application 132, and communicate with agent 134 during execution of the application. BCI may also be used to monitor one or more sockets of the application and/or application server in order to monitor the socket and capture packets coming over the socket.

In some embodiments, server 130 may include applications and/or code other than a virtual machine. For example, server 130 may include Java code, .Net code, PHP code, Ruby code, C code or other code to implement applications and process requests received from a remote source.

Agents 134 on application server 130 may be installed, downloaded, embedded, or otherwise provided on application server 130. For example, agents 134 may be provided in server 130 by instrumentation of object code, downloading the agents to the server, or in some other manner. Agents 134 may be executed to monitor application server 130, monitor code running in a or a virtual machine 132 (or other program language, such as a PHP, .Net, or C program), machine resources, network layer data, and communicate with byte instrumented code on application server 130 and one or more applications on application server 130.

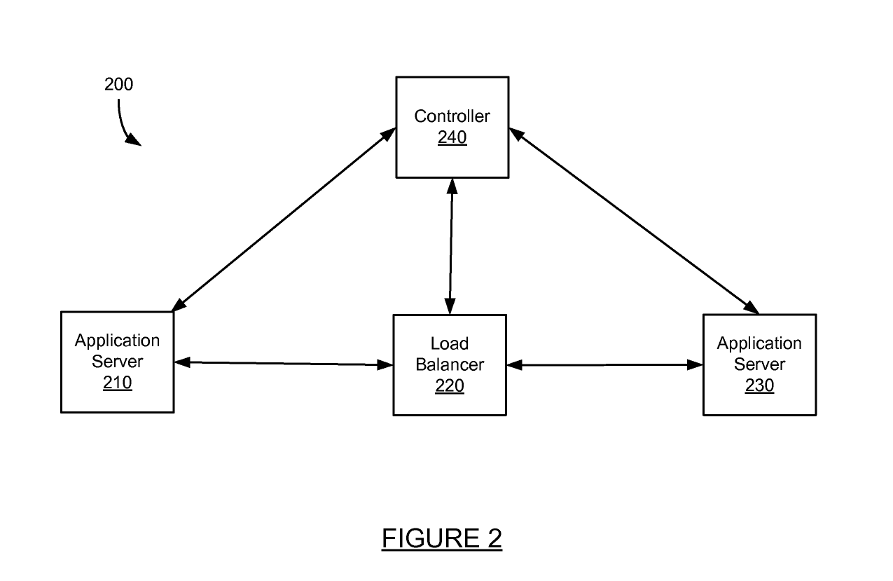

Each of agents 134, 144, 154 and 164 may include one or more agents, such as an application agents, machine agents, and network agents. An application agent may be a type of agent that is suitable to run on a particular host. Examples of application agents include a JAVA agent, .Net agent, PHP agent, and other agents. The machine agent may collect data from a particular machine on which it is installed. A network agent may capture network information, such as data collected from a socket. Agents are discussed in more detail below with respect to FIG. 2.

Agent 134 may detect operations such as receiving calls and sending requests by application server 130, resource usage, and incoming packets. Agent 134 may receive data, process the data, for example by aggregating data into metrics, and transmit the data and/or metrics to controller 190. Agent 134 may perform other operations related to monitoring applications and application server 130 as discussed herein. For example, agent 134 may identify other applications, share business transaction data, aggregate detected runtime data, and other operations.

An agent may operate to monitor a node, tier or nodes or other entity. A node may be a software program or a hardware component (e.g., memory, processor, and so on). A tier of nodes may include a plurality of nodes which may process a similar business transaction, may be located on the same server, may be associated with each other in some other way, or may not be associated with each other.

An application agent may be an agent suitable to instrument or modify, collect data from, and reside on a host. The host may be a Java, PHP, .Net, Node.JS, or other type of platform. Application agent 220 may collect flow data as well as data associated with the execution of a particular application. The application agent may instrument the lowest level of the application to gather the flow data. The flow data may indicate which tier is communicating which with which tier and on which port. In some instances, the flow data collected from the application agent includes a source IP, a source port, a destination IP, and a destination port. The application agent may report the application data and call chain data to a controller. The application agent may report the collected flow data associated with a particular application to network agent 230.

A network agent may be a standalone agent that resides on the host and collects network flow group data. The network flow group data may include a source IP, destination port, destination IP, and protocol information for network flow received by an application on which network agent 230 is installed. The network agent 230 may collect data by intercepting and performing packet capture on packets coming in from a one or more sockets. The network agent may receive flow data from an application agent that is associated with applications to be monitored. For flows in the flow group data that match flow data provided by the application agent, the network agent rolls up the flow data to determine metrics such as TCP throughput, TCP loss, latency and bandwidth. The network agent may then reports the metrics, flow group data, and call chain data to a controller. The network agent may also make system calls at an application server to determine system information, such as for example a host status check, a network status check, socket status, and other information.

A machine agent may reside on the host and collect information regarding the machine which implements the host. A machine agent may collect and generate metrics from information such as processor usage, memory usage, and other hardware information.

Each of the application agent, network agent, and machine agent may report data to the controller. Controller 210 may be implemented as a remote server that communicates with agents located on one or more servers or machines. The controller may receive metrics, call chain data and other data, correlate the received data as part of a distributed transaction, and report the correlated data in the context of a distributed application implemented by one or more monitored applications and occurring over one or more monitored networks. The controller may provide reports, one or more user interfaces, and other information for a user.

Agent 134 may create a request identifier for a request received by server 130 (for example, a request received by a client 105 or 115 associated with a user or another source). The request identifier may be sent to client 105 or mobile device 115, whichever device sent the request. In embodiments, the request identifier may be created when a data is collected and analyzed for a particular business transaction. Additional information regarding collecting data for analysis is discussed in U.S. patent application no. U.S. patent application Ser. No. 12/878,919, titled “Monitoring Distributed Web Application Transactions,” filed on Sep. 9, 2010, U.S. Pat. No. 8,938,533, titled “Automatic Capture of Diagnostic Data Based on Transaction Behavior Learning,” filed on Jul. 22, 2011, and U.S. patent application Ser. No. 13/365,171, titled “Automatic Capture of Detailed Analysis Information for Web Application Outliers with Very Low Overhead,” filed on Feb. 2, 2012, the disclosures of which are incorporated herein by reference.

Each of application servers 140, 150 and 160 may include an application and agents. Each application may run on the corresponding application server. Each of applications 142, 152 and 162 on application servers 140-160 may operate similarly to application 132 and perform at least a portion of a distributed business transaction. Agents 144, 154 and 164 may monitor applications 142-162, collect and process data at runtime, and communicate with controller 190. The applications 132, 142, 152 and 162 may communicate with each other as part of performing a distributed transaction. In particular each application may call any application or method of another virtual machine.

Asynchronous network machine 170 may engage in asynchronous communications with one or more application servers, such as application server 150 and 160. For example, application server 150 may transmit several calls or messages to an asynchronous network machine. Rather than communicate back to application server 150, the asynchronous network machine may process the messages and eventually provide a response, such as a processed message, to application server 160. Because there is no return message from the asynchronous network machine to application server 150, the communications between them are asynchronous.

Data stores 180 and 185 may each be accessed by application servers such as application server 150. Data store 185 may also be accessed by application server 150. Each of data stores 180 and 185 may store data, process data, and return queries received from an application server. Each of data stores 180 and 185 may or may not include an agent.

Controller 190 may control and manage monitoring of business transactions distributed over application servers 130-160. In some embodiments, controller 190 may receive application data, including data associated with monitoring client requests at client 105 and mobile device 115, from data collection server 160. In some embodiments, controller 190 may receive application monitoring data and network data from each of agents 112, 119, 134, 144 and 154. Controller 190 may associate portions of business transaction data, communicate with agents to configure collection of data, and provide performance data and reporting through an interface. The interface may be viewed as a web-based interface viewable by client device 192, which may be a mobile device, client device, or any other platform for viewing an interface provided by controller 190. In some embodiments, a client device 192 may directly communicate with controller 190 to view an interface for monitoring data.

Client device 192 may include any computing device, including a mobile device or a client computer such as a desktop, work station or other computing device. Client computer 192 may communicate with controller 190 to create and view a custom interface. In some embodiments, controller 190 provides an interface for creating and viewing the custom interface as a content page, e.g., a web page, which may be provided to and rendered through a network browser application on client device 192.

Applications 132, 142, 152 and 162 may be any of several types of applications. Examples of applications that may implement applications 132-162 include a Java, PHP, .Net, Node.JS, and other applications.

FIG. 2 is a block diagram of a network infrastructure. The network infrastructure of FIG. 2 includes application servers 210 and 230, load balancer 220, and controller 240. A business transaction may be processed by applications hosted on application servers 210 and 230. The network flow that handles communication between application servers 210 and 230 as part of the distributed business transaction travels through load balancer 220. As part of monitoring the network flow in and out of application servers 210 and 230, network agents may collect data allowing the present system (in particular, controller 240) to determine if there is a performance issue with load balancer 220. Performance issues may include inadequate bandwidth, low server pools, and other issues that may affect quality of service.

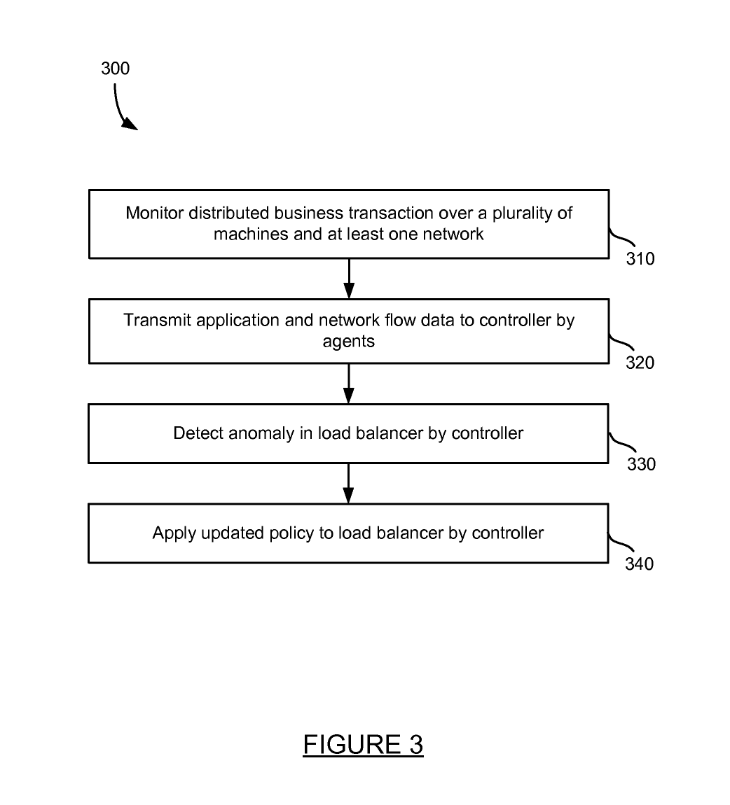

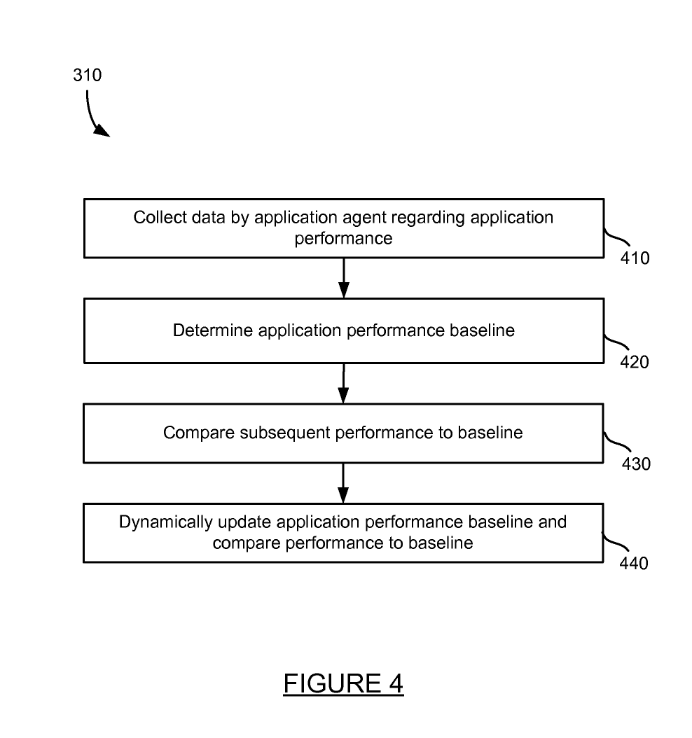

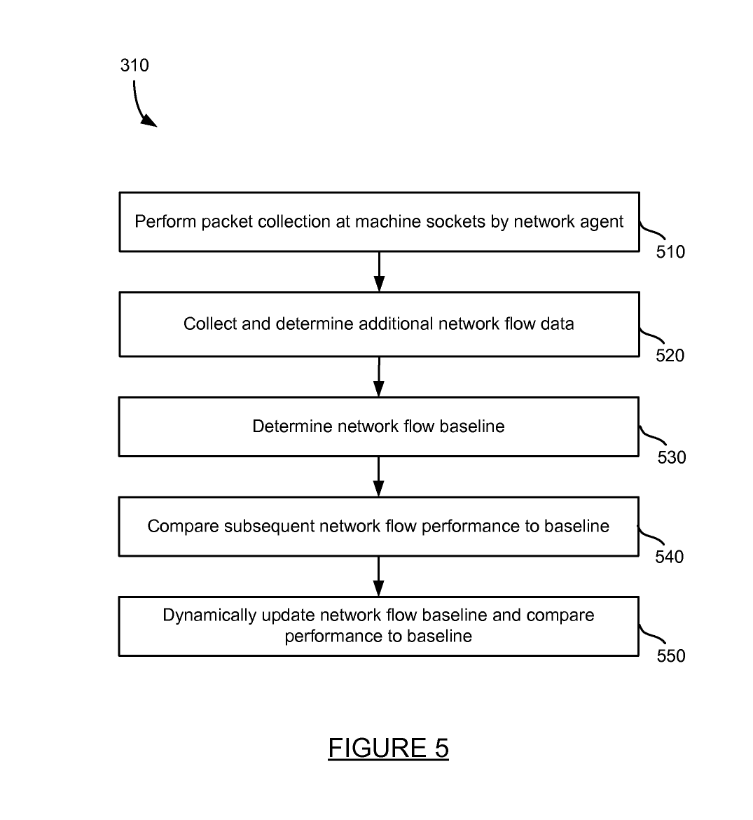

FIG. 3 is a method for automatically monitoring and updating a network infrastructure. First, distributed business transactions are monitored over a plurality of machines and at least one network at step 210. Multiple agents may be used to monitor the distributed business transaction. Application agents may be used to monitor applications that process requests and perform functions that make up the distributed business transaction. Network agents may be used to monitor one or more sockets that are used to process communications between machines as part of a distributed business transaction. More details for monitoring a distributed business transaction by an application agent are discussed with respect to the method of FIG. 4. More details for monitoring a distributed business transaction by a network agent are discussed with respect to the method of FIG. 5.

More information for monitoring network flows is discussed in patent application Ser. No. ______, filed Nov. 30, 2015, titled “Network Aware Distributed Business Transaction Anomaly Detection,” the disclosure of which is incorporated herein by reference.

One or more agents may collect application data and network flow data from one or more machines and transmit the data to a controller. A network agent may determine if it has detected an anomaly in accordance with parameters received by the application agent. In some instances, the application agent may provide parameters to the network agent specifying where to identify an anomaly. For example, an application agent may indicate a particular address location for a source of a network flow and address location of for the destination of the network flow, as well as a time period over which the anomaly would have occurred. An example of a location address may include an Internet protocol address, such as an Internet protocol address for a source machine and destination machine. The network machine may then analyze the sockets being monitored to determine if any socket is associated with a source and destination address location that match those received from the application agent and if, for network flow associated with that socket, if there is an anomaly detected for the network flow during the specified period of time.

If an anomaly is detected by the network agent between the source and destination location addresses for the specified period of time agent, the network flow anomaly data is provided to the application agent by the network agent. The network flow anomaly data may include TCP statistics, latency, throughput, relay transmission, and other TCP data associated with the particular network flow. The network data reported by the application agent may also include a tuple of the source IP, destination IP, source port, and destination port associated with the network flow.

One or more agents may transmit application and network flow data (with or without anomaly data) to a controller at step 320. Associating the network flow data with the business transaction may include adding business transaction context information such as a business transaction identifier, tier identification for tiers involved in the network flow, node identification information for nodes involved in the flow, and the portion of the business transaction being executed over the particular network flow.

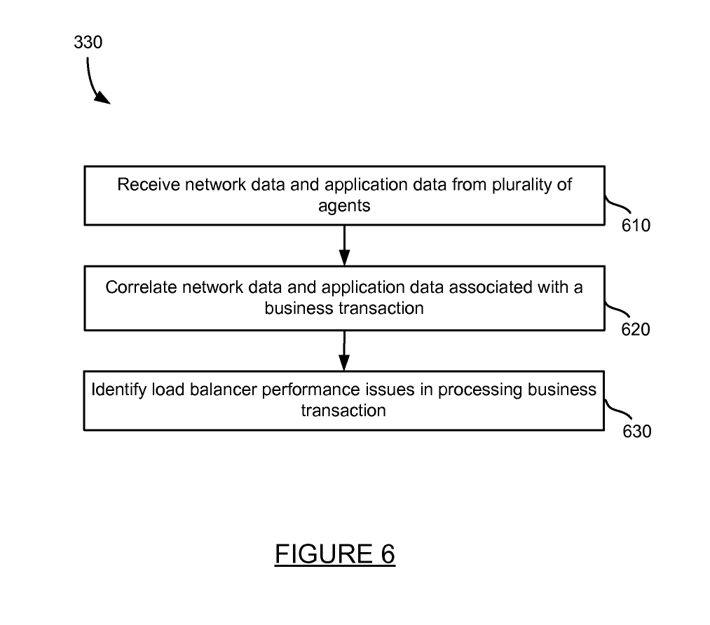

A controller receives the application anomaly and network flow data from a plurality of agents on a plurality of machines and may identify a load balancer anomaly at step 330. The anomaly may be detected by analysis of the application data, network flow data, including network flow anomaly data, and knowledge of the network infrastructure. More details for detecting a load balancer anomaly is discussed with respect to the method of FIG. 6.

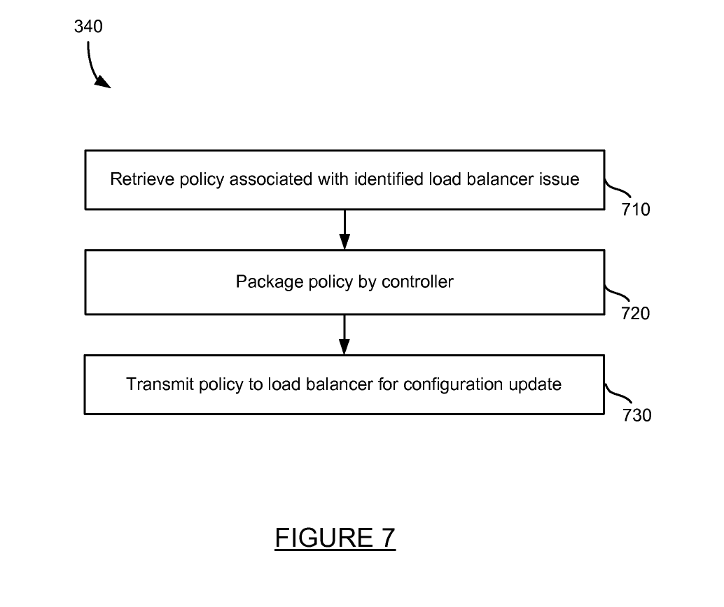

An updated policy is automatically applied to the load balancer by the controller at step 340. Applying the policy may include automatically generating the appropriate policy and submitting a package containing the policy to the load balancer or a controller configured to update the load balancer. More details for applying the load balancer policy is discussed with respect to the method of FIG. 7.

FIG. 4 is a method for monitoring distributed business transactions by an application agent. The method of FIG. 4 provides more detail for step 310 the method of FIG. 3. First, data is collected by an application agent regarding application performance at step 410. An application performance baseline is then determined at step 420. The baseline for an application may be determined by taking a moving average window of the response time as well as other metrics associated with a particular application, call, requests, or other function or element being monitored. Subsequent performance of the particular element or application is then compared to the baseline at step 430. As application execution continues, the application performance baseline is dynamically updated with the moving average window and compared to the performance baseline at step 440. If a detected value for the application performance, such as response time for a particular call, exceeds a standard deviation of the baseline by two times, three times, or some other value determined by a system designer, that value is identified as an anomaly.

FIG. 5 is a method for monitoring distributed business transactions by network agent. The method of FIG. 5 provides more detail for step 310 of the method of FIG. 3. First, packet collection is performed at machine sockets by network agent at step 510. In addition to collecting packets, additional network flow data is collected and determined at step 520. The additional data may include TCP header data, IP sequence numbers, TCP control flags and data, acknowledgment information, and other data. The additional network flow data may also include tuples for each socket, such as a source IP, destination IP, source port and destination port for each socket. The latency, throughput and relay transmission data is determined for each network flow. A network flow baseline is then determined for each network flow metric at step 430.

Subsequent network flow performance is then compared to the baseline at step 540. As with the application metrics with respect to FIG. 5, if network flow metric values exceed two times or three times a baseline, the particular metric is identified as an anomaly. The network flow baseline is dynamically updated and subsequent performance is compared to the dynamically updated baseline at step 550.

FIG. 6 is a method automatically identifying an anomaly in a load balancer. The method of FIG. 6 provides more detail for step 330 of the method of FIG. 3. First, network data and application data received from a plurality of agents at step 610. Next, the network data and application data are correlated so that they are associated with a business transaction at step 620. Correlation may be based on Internet protocol addresses, business transaction identifier information, and other data. Next, load balancer performance issues may be identified in the processing of the business transaction at step 630. The load balancer performance issues may be determined at least in part from the network flow data, application data, and knowledge of the network infrastructure. For example, if a network flow from a first machine to the load balancer is known to be operating normally, while the network flow from the load balancer to a second machine is operating very slowly, it can be determined that the load balancer is not operating properly to maintain desirable performance of the business transaction. In particular, the load balancer may have a less than desirable bandwidth, number of servers, or other resources required to process a business transaction. The load balancer performance issues may be tied to a particular business transaction, rather than associated with general performance issues.

FIG. 7 is a method for automatically applying a policy update to a load balancer by a controller. The method of FIG. 7 provides more detail for step 340 of the method of FIG. 3. First, a policy associated with the identified load balancer issue is retrieved by the controller at step 710. The controller may include a library or table policy information, or may retrieve the pulse information from a remote database or other location.

The controller may generate a policy based on the anomalies detected on the application transactions and remediate them by applying these policies on the infrastructure in conjunction with the Software Defined Network Controllers and other Policy based controller in addition to the Load balancers.

Once retrieved, the policy may be packaged by controller for transmittal to the load balancer at step 720. Once packaged, the policy may be transmitted to load balancer for updating a configuration of the load balancer at step 730. The policy may indicate an updated configuration for the load balancer to operate in such a manner as to provide a better quality of service when handling the business transaction. For example, the policy may indicate that when a particular business transaction is detected by the load balancer, the load balancer should implement a higher bandwidth or number of servers while the business transaction is being processed. In some instances, the controller may implement the policy directly through communication with the load balancer or provide the policy to an external and intermediary software controller that may update the load balancer itself.

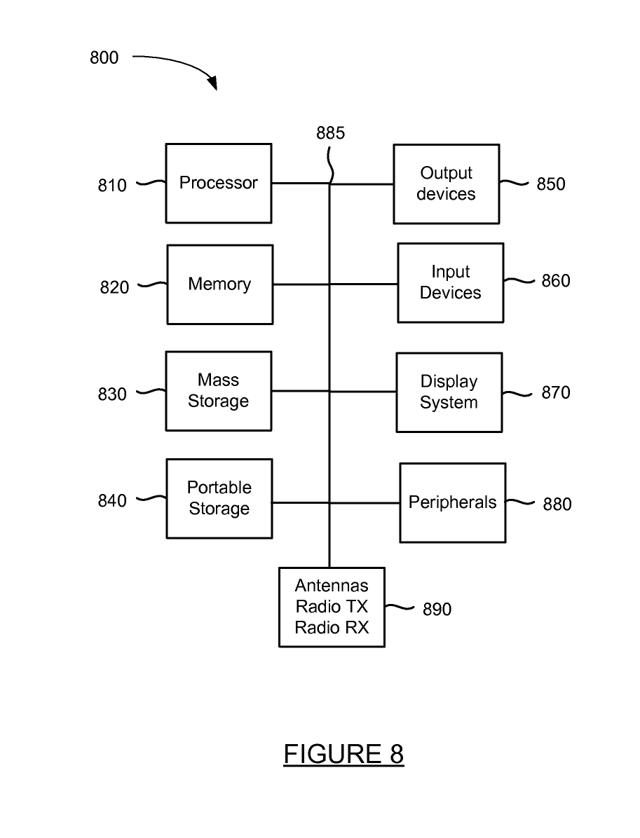

FIG. 8 is a block diagram of a system for implementing the present technology. System 800 of FIG. 8 may be implemented in the contexts of the likes of client computer 105 and 192, servers 125, 130, 140, 150, and 160, machine 170, data stores 180 and 190, and controller 190. The computing system 800 of FIG. 8 includes one or more processors 810 and memory 820. Main memory 820 stores, in part, instructions and data for execution by processor 810. Main memory 820 can store the executable code when in operation. The system 800 of FIG. 8 further includes a mass storage device 830, portable storage medium drive(s) 840, output devices 850, user input devices 860, a graphics display 870, and peripheral devices 880.

The components shown in FIG. 8 are depicted as being connected via a single bus 890. However, the components may be connected through one or more data transport means. For example, processor unit 810 and main memory 820 may be connected via a local microprocessor bus, and the mass storage device 830, peripheral device(s) 880, portable storage device 840, and display system 870 may be connected via one or more input/output (I/O) buses.

Mass storage device 830, which may be implemented with a magnetic disk drive, an optical disk drive, a flash drive, or other device, is a non-volatile storage device for storing data and instructions for use by processor unit 810. Mass storage device 830 can store the system software for implementing embodiments of the present invention for purposes of loading that software into main memory 820.

Portable storage device 840 operates in conjunction with a portable non-volatile storage medium, such as a floppy disk, compact disk or Digital video disc, USB drive, memory card or stick, or other portable or removable memory, to input and output data and code to and from the computer system 800 of FIG. 8. The system software for implementing embodiments of the present invention may be stored on such a portable medium and input to the computer system 800 via the portable storage device 840.

Input devices 860 provide a portion of a user interface. Input devices 860 may include an alpha-numeric keypad, such as a keyboard, for inputting alpha-numeric and other information, a pointing device such as a mouse, a trackball, stylus, cursor direction keys, microphone, touch-screen, accelerometer, and other input devices Additionally, the system 800 as shown in FIG. 8 includes output devices 850. Examples of suitable output devices include speakers, printers, network interfaces, and monitors.

Display system 870 may include a liquid crystal display (LCD) or other suitable display device. Display system 870 receives textual and graphical information, and processes the information for output to the display device. Display system 870 may also receive input as a touch-screen.

Peripherals 880 may include any type of computer support device to add additional functionality to the computer system. For example, peripheral device(s) 880 may include a modem or a router, printer, and other device.

The system of 800 may also include, in some implementations, antennas, radio transmitters and radio receivers 890. The antennas and radios may be implemented in devices such as smart phones, tablets, and other devices that may communicate wirelessly. The one or more antennas may operate at one or more radio frequencies suitable to send and receive data over cellular networks, Wi-Fi networks, commercial device networks such as a Bluetooth devices, and other radio frequency networks. The devices may include one or more radio transmitters and receivers for processing signals sent and received using the antennas.

The components contained in the computer system 800 of FIG. 8 are those typically found in computer systems that may be suitable for use with embodiments of the present invention and are intended to represent a broad category of such computer components that are well known in the art. Thus, the computer system 800 of FIG. 8 can be a personal computer, hand held computing device, smart phone, mobile computing device, workstation, server, minicomputer, mainframe computer, or any other computing device. The computer can also include different bus configurations, networked platforms, multi-processor platforms, etc. Various operating systems can be used including Unix, Linux, Windows, iOS, Android, C, C++, Node.JS, and other suitable operating systems.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A method for monitoring a distributed business transaction, comprising:
monitoring a distributed business transaction over a plurality of machines and at least one network;
identifying an anomaly in a network machine within the network architecture that processes the distributed business transaction by a remote server in communication with the plurality of machines; and
automatically applying a policy update to the network machine in the network architecture by the remote server.

2. The method of claim 1, wherein the network machine is a load balancer.

3. The method of claim 1, wherein the anomaly is detected in part based on network flow data monitored by agents on the plurality of machines.

4. The method of claim 3, wherein the policy update is generated automatically based on the network flow data.

5. The method of claim 1, wherein monitoring includes capturing each packet of a network flow associated with a distributed business transaction.

6. The method of claim 1, wherein monitoring includes collecting metrics associated with performance of a network flow between one or more machines that process the distributed business transaction and communicate with the network machine.

7. The method of claim 1, further comprising determining an anomaly based on a baseline for a metric associated with performance of the network flow.

8. A non-transitory computer readable storage medium having embodied thereon a program, the program being executable by a processor to perform a method for monitoring a business transaction, the method comprising:
monitoring a distributed business transaction over a plurality of machines and at least one network;
identifying an anomaly in a network machine within the network architecture that processes the distributed business transaction by a remote server in communication with the plurality of machines; and
automatically applying a policy update to the network machine in the network architecture by the remote server.

9. The non-transitory computer readable storage medium of claim 8, wherein the network machine is a load balancer.

10. The non-transitory computer readable storage medium of claim 8, wherein the anomaly is detected in part based on network flow data monitored by agents on the plurality of machines.

11. The non-transitory computer readable storage medium of claim 10, wherein the policy update is generated automatically based on the network flow data.

12. The non-transitory computer readable storage medium of claim 8, wherein monitoring includes capturing each packet of a network flow associated with a distributed business transaction.

13. The non-transitory computer readable storage medium of claim 8, wherein monitoring includes collecting metrics associated with performance of a network flow between one or more machines that process the distributed business transaction and communicate with the network machine.

14. The non-transitory computer readable storage medium of claim 8, the method further comprising determining an anomaly based on a baseline for a metric associated with performance of the network flow.

15. A system for monitoring a business transaction performed by multiple computers, comprising:
a server including a memory and a processor; and
one or more modules stored in the memory and executed by the processor to monitor a distributed business transaction over a plurality of machines and at least one network, identify an anomaly in a network machine within the network architecture that processes the distributed business transaction by a remote server in communication with the plurality of machines, and automatically apply a policy update to the network machine in the network architecture by the remote server.

16. The system of claim 15, wherein the network machine is a load balancer.

17. The system of claim 15, wherein the anomaly is detected in part based on network flow data monitored by agents on the plurality of machines.

18. The system of claim 17, wherein the policy update is generated automatically based on the network flow data.

19. The system of claim 15, wherein monitoring includes capturing each packet of a network flow associated with a distributed business transaction.

20. The system of claim 15, wherein monitoring includes collecting metrics associated with performance of a network flow between one or more machines that process the distributed business transaction and communicate with the network machine.

21. The system of claim 15, the one or more modules further executable to determine an anomaly based on a baseline for a metric associated with performance of the network flow.
